(19) United States
(12) Patent Application Publication
(10) Pub. No.: US 2026/0152603 A1
(43) Pub. Date: Jun. 4, 2026

(54) PROCESS FOR THE PRODUCTION OF A BIODEGRADABLE POLYESTER (CO)POLYMER

(71) Applicant: Avantium Knowledge Centre B.V., Amsterdam (NL)

(72) Inventors: Kevin van der Maas, Amsterdam (NL); Bing Wang, Amsterdam (NL); Robert-Jan Van Putten, Amsterdam (NL); Gerardus Johannes Maria Gruter, Amsterdam (NL)

(21) Appl. No.: 19/123,696

(22) PCT Filed: Oct. 30, 2023
(86) PCT No.: PCT/EP2023/080224

§ 371 Date: Apr. 23, 2025

(30) Foreign Application Priority Data
Nov. 1, 2022 (EP) 22204847.2

(51) Int. Cl. C08G 63/672; C08G 63/78

(52) U.S. Cl. CPC C08G 63/672; C08G 63/78

(57) ABSTRACT

The invention relates to a process for the production of an oxalate polyester (co)polymer, comprising the use of bis(2-methoxyphenyl) oxalate to introduce oxalate monomer units into the polymer chain, comprising at least steps (a) and (b):
(a) an esterification/transesterification step wherein at least one dicarboxylic acid or an ester derivative thereof is/are reacted with an excess of at least one diol compound to form a pre-polycondensation product comprising alcohol end groups, or otherwise producing such pre-polycondensation product;
(b) a polymerization step comprising polycondensation of the product of step (a) with bis(2-methoxyphenyl) oxalate in a molar amount that is equal to between about 0.4 to about 0.6 equivalents of the molar amount of alcohol end groups in the pre-polycondensation product of step (a).
The process is an efficient process for the production of novel and existing oxalate polyester (co)polymers, also with high molecular weight, and optionally without the need for the addition of a metal catalyst.

### FIELD OF THE INVENTION

The invention relates to a process for the production of a biodegradable polyester (co)polymer, in particular of a (catalyst free) oxalate containing polyester (co)polymer, and to a polyester (co)polymer obtainable by, or obtained by, said process.

### BACKGROUND OF THE INVENTION

Currently, almost all plastics are still made of a fossil based feedstock. Only about 1% of the total plastics production relates to plastics obtained from a bio-based feedstock. In order to move to a more sustainable future, novel plastics should be developed which are produced from sustainable sources such as biomass, CO₂ or recycled content. To be able to fully replace fossil-based plastics, similar or preferably better material properties are needed. These include high glass transition temperature, good mechanical strength and barrier properties. Furthermore, to make it economically viable, the polymer production process should be energy-efficient and scalable. In addition, many of the plastics used today show very limited to no degradation, for most it can even take hundreds of years. Today, plastic can be almost found everywhere in the environment, it is found in sea water, freshwater, food and even drinking water. This has many already noticeable harmful effects to our health and environment, and many potentially harmful effects are under investigation. Despite the fact that plastic should not be spilled into the environment and build-up should be minimized by proper disposal and public awareness, with as main goal reuse and recycling, it appears to be unavoidable that there will always be leakage into the environment. Therefore, when developing novel plastics it is important to take into account the lifetime expectancy of the application of the product. The plastic should be durable throughout its use, and should have some degree of degradability after use to prevent environmental build-up when the plastic finds its fate in nature.

As a consequence, there is a need for biodegradable polyesters, which for example might be produced when using isosorbide and/or oxalate as monomer units. These building blocks have the potential to be readily obtained from renewable resources.

Isosorbide is a rigid, chiral and non-toxic molecule containing two hydroxyl groups, a biobased chemical which can be obtained from glucose by the dehydration of sorbitol. It is available on large scale with an annual production capacity of 20,000 kiloton (2015). When incorporated in polymers, isosorbide enhances the thermomechanical stability, provides good mechanical properties, and gives non-toxic degradation products. Therefore, it has great potential to be used as building block in polyesters.

Oxalates are readily obtained from biorenewable resources, and technologies are available to electrochemically produce oxalates from CO₂, providing routes to sustainably produce polyoxalates. Polyoxalates are known to have good mechanical properties, have a remarkably fast hydrolysis, and are readily biodegradable. Oxalate is the simplest dicarboxylate, in which two carboxyl groups are connected to each other, which provides interesting properties, such as high reactivity and rigidity.

Apart from improved biodegradability, one of the most important goals of new polymerization processes is to obtain polymers with a molecular weight high enough for the desired application(s). This is important as the molecular weight of the polymer relates to polymer performance e.g., strength, toughness and durability. The use of polymers with insufficient molecular weight may lead to application failures. Therefore, many studies concerning polymerization processes and the conditions used in those processes relate to realizing the target (high) molecular weight.

Polyesterification is a reversible polymerization reaction with a relatively low equilibrium constant, which means that removal of the condensation product(s) has an impact on the molecular weight that can be achieved. Additionally, applying an (high) vacuum during the polymerization reaction may improve the molecular weight that can be achieved. Melt polycondensation at reduced pressure is commonly used in polyesterification processes for removal of the condensation product(s). However, the increase of molecular weight of the polymers during that process also increases the viscosity of the melt material, which complicates the removal of condensation product(s). This may eventually become a limiting factor. Removal of condensation product(s) can be improved, for example by using higher temperatures, longer reaction times, catalysts and improved reactor designs. However, under melt conditions, limited mass transfer due to high viscosity of the melt material, in combination with longer residence times and (potential) chemical degradation, may limit the possibilities to obtain higher molecular weights. In order to obtain high molecular weights, an additional solid-state polymerization (SSP) step may be required. In SSP, polymer pellets are heated below the melting point while being rotated under a nitrogen flow or vacuum. A drawback of SSP is that due to the low mobility of the end groups and condensate in the solid state, this is time and energy consuming, and therefore an expensive process.

When less reactive diols such as isosorbide are used in polyesterification, it is difficult to obtain sufficiently high molecular weights. As discussed, incorporation of isosorbide is interesting due to its additional benefits on thermomechanical stability and mechanical performance, which opens new possibilities for applications. Isosorbide is, however, less reactive due to its secondary alcohol groups, and melt polycondensation becomes considerably more difficult with increasing isosorbide content. Furthermore, the crystallinity of the polymer is lost with isosorbide contents above around 15%, which makes it impossible to use SSP, as an amorphous polymer would clump together.

Also the use of oxalic acid in polyesterification to produce polyoxalates with high glass transition temperatures presents challenges. The higher temperatures required for melt polycondensation prevents oxalic acid from being used directly. Depending on the conditions, oxalic acid and oxalic acid end groups are prone to decomposition at temperatures ranging from 127 to 157° C. Oxalic acid also has a substantial vapor pressure at temperatures above 100° C. and starts subliming. These disadvantages hamper processes for obtaining high molecular weight polyoxalates. In addition, one of the thermal decomposition products of oxalate is formate. Formate only forms single ester bonds, capping the polymer chain and preventing further chain growth. To prevent this, esters of oxalic acid may be used.

Polyoxalate polymers with isosorbide have been demonstrated to possess biodegradability, interesting oxygen barrier, chemical resistance and transparency and possibly high Tg (e.g. up to 172° C., see JP2006161017). Polymers consisting of oxalate and isosorbide (PISOX) degrade typically in less than a year, which is, however, too fast for many applications. As a further disadvantage, due to the low reactivity of the secondary hydroxyl groups of isosorbide it is difficult to produce high molecular weight polymers (Mn>10 kDa) by conventional polyesterification strategies. In order to obtain sufficiently high molecular weights, the amount of isosorbide used is typically low (<50%). Strategies for obtaining high proportions of isosorbide in the chain require long reaction times and high temperatures, or hazardous solvent and reactants (typically acyl chlorides). This is reflected by publications wherein, until now, only relatively low molecular weight polymers derived from isosorbide are reported.

Recent developments have shown that diphenyl oxalate can be reacted with isosorbide to produce polyoxalates with a high content of isosorbide (see e.g. WO 2018211133). There are however some practical downsides to this strategy. In such a polymerization reaction, the molecule phenol plays a considerable part and has a stoichiometric coefficient of two. As a result, half of the reactor volume is needed for phenol, which doubles the required size of the reactor equipment. This disadvantage also plays a role in transportation, recycling and monomer production. Next to this, phenol is a toxic substance which requires additional considerations when being processed. Due to reversible nature of the esterification reaction, the residual amounts of phenol in the resin should also be taken into account.

Next to novel PISOX polyesters, another polymer of interest for biodegradability improvement is polyethylene terephthalate (PET). PET is one of the most common polyesters used in the textile and packaging industry due to its good mechanical and barrier properties. The global PET resin production in 2018 was 22.521 million tonnes by volume. Unfortunately, despite being a highly recyclable material, only a small portion ends up being recycled. This results in around 10 million tons of PET to be discarded as waste. A part of the waste leaks into the environment by littering or being inadequately disposed. Due to its high chemical stability, PET waste buildup in rivers, seas and landfill, causing serious environmental problems. In order to reduce the pollution with PET, research is currently aimed at improving the biodegradability of the polymer. Depending on the application, the copolymer content can be varied to change degradability of the polymer. A proper choice of copolymer may also enhance the chemical recyclability, e.g. due to the presence of more labile bonds.

The use of oxalate in a PET copolymer to increase biodegradability has not yet been fully studied. Some patent documents reported about polyethylene terephthalate copolymers containing oxalate units, such as CN102276808 and CN113072690. The latter document describes reacting oxalic acid with other components at a temperature of 180° C., but at those temperatures it is known that oxalic acid decomposes. CN102276808 describes the use of dimethyl oxalate and diethyl oxalate; however, the polymers produced have glass transition temperatures close to that of PET, suggesting that not all oxalate units are actually incorporated into the polymer chains.

The current inventors have found that ring formation readily takes place at elevated temperatures between ethylene glycol and oxalate to form ethylene oxalate (six-membered ring structure), which prevents successful use of conventional synthesis strategies for oxalate polyesters. Under elevated temperature and reduced pressure, ethylene oxalate sublimes and leaves the reactor, driving the reaction forward, however, without effective incorporation of oxalate units.

To incorporate oxalate into the PET polymer chain without experiencing problems with ethylene oxalate formation, a low polymerization temperature would be required. Performing polymerizations at lower temperatures brings challenges as the reactivity between the monomers is reduced, and temperatures should be high enough to still melt the polymer. Although oxalic acid per se has a high reactivity already at low temperatures, it copes with thermal decomposition and sublimation starting at temperatures of around 130° C. On the other hand, alkyl oxalates are significantly less reactive and need a combination of a high temperature and a strong catalyst to be able to produce sufficiently high molecular weights.

Therefore, there is a need for an improved process for the production of a range of sufficiently biodegradable oxalate polyesters, which process can be performed at relatively low temperatures, avoids the use/presence of toxic components such as phenol, and does not necessarily require solid-state polymerization for obtaining high molecular weights.

### SUMMARY OF THE INVENTION

According to the present invention, such an improved process is provided. The present invention relates to a process for the production of an oxalate polyester (co)polymer, comprising the use of bis(2-methoxyphenyl) oxalate to introduce oxalate monomer units into the polymer chain, comprising at least steps (a) and (b):
(a) an esterification/transesterification step wherein at least one dicarboxylic acid or an ester derivative thereof is/are reacted with an excess of at least one diol compound to form a pre-polycondensation product comprising alcohol end groups, or otherwise producing such pre-polycondensation product;
(b) a polymerization step comprising polycondensation of the product of step (a) with bis(2-methoxyphenyl) oxalate in a molar amount that is equal to between about 0.4 and about 0.6 equivalents of the molar amount of alcohol end groups in the pre-polycondensation product of step (a).

Advantageously, it is very favorable to use bis(2-methoxyphenyl) oxalate for the production of an oxalate polyester (co)polymer, as the inventors have found that the 2-methoxyphenyl group (also referred to as guaiacyl group) has exceptional leaving group properties in transesterification reactions. Consequently, the high reactivity of the bis(2-methoxyphenyl) oxalate ester allows performing reactions at relatively low temperatures and provides flexibility in its use in polymerization processes.

A wide range of oxalate containing polyester (co)polymers may conveniently be produced using the bis(2-methoxyphenyl) oxalate ester of the present invention. An advantageous process is provided herewith for the preparation of both existing and, in particular, novel polyester (co)polymers with favorable properties. In addition, relatively high number average molecular weights of the polyester (co)polymer end product may be obtained due to the high reactivity of the bis(2-methoxyphenyl) oxalate ester.

Thus, as a further aspect, the invention relates to certain novel oxalate containing polyester (co)polymers, and also to novel (co)polymers that were produced without addition of a catalyst.

In addition, the invention provides a composition comprising any one of said novel polyester (co)polymers and in addition one or more additives and/or one or more additional polymers.

Further, the invention provides an article comprising the polyester (co)polymer according to the present invention or a composition comprising said polyester (co)polymer and one or more additives and/or additional (co)polymers.

The novel high molecular weight polyester (co)polymers and/or compositions produced according to the invention can advantageously be used in a broad range of (industrial) applications, such as in fibres, injection (blow) moulded parts and bottles, 3D printing, packaging materials, etc.

### DETAILED DESCRIPTION OF THE INVENTION

The present invention relates to an improved process for the production of oxalate polyester (co)polymers.

By a “polyester” herein is understood a polymer comprising a plurality of monomer units linked via ester functional groups in its main chain. An ester functional group can be formed by reacting a hydroxyl group (—OH) with a carboxyl/carboxylic acid group (—C(═O) OH). Typically, a polyester is a synthetic polymer formed by the reaction of one or more bifunctional carboxylic acids with one or more bifunctional hydroxyl compounds. Polyesters may also comprise units derived from monomers carrying both a hydroxyl group and a carboxylic acid group, such as polylactic acid (PLA), polyglycolic acid (PGA), poly(lactic-co-glycolic acid) (PLGA), polyhydroxyalkanoates (PHA), and the like. By a “polyester copolymer” is herein understood a polyester wherein three or more types of monomer units are joined in the same polymer main chain.

By a “monomer unit” is herein understood a unit as included in a polyester copolymer or oligomer, which unit can be obtained after polymerization of a monomer, that is, a “monomer unit” is a constitutional unit contributed by a single monomer or monomer compound to the structure of the polymer or oligomer, herein in particular the smallest diol or di-acid repeating unit.

By a “monomer” or “monomer compound” is herein understood the smallest building block used as the starting compound to be polymerized, such as a diol or di-acid compound, but also a hydroxycarboxylic acid.

By an “oligomer” or “oligomer compound” is herein understood a molecular structure comprising an in total average number of monomer units of in the range from equal to or more than 2 to equal to or less than 25 monomer units. Next to diol and di-acid derived monomer units, also other monomer units may be part of the oligomer, such as hydroxycarboxylic acid derived monomer units, in particular derived from α-hydroxycarboxylic acids, such as glycolic acid, lactic acid, mandelic acid, 3-alkoxy carbonic acid, and the like.

By the wording “pre-polycondensation product” is herein understood a polymer of limited chain length that can be used as starting polymeric material for oxalate insertion. Such pre-polycondensation product can be obtained by the esterification/transesterification step defined in step (a), but also pre-polycondensation products resulting from other processes, which may be performed separately, even in a different reactor. For example, suitable pre-polycondensation products may be terephthalate oligomers with alcohol end groups, e.g. produced by recycling processes, such as PET glycolysis products, including bis(2-hydroxyethyl) terephthalate, and higher PET oligomers (see e.g. T. Spychaj in “Handbook of thermoplastic polymers”, 2002 Wiley, Chapter 27, p 1259-61).

The present process relates to the production of an oxalate polyester (co)polymer, comprising at least steps (a) and (b), wherein in the polymerization step (b) oxalate monomer units are introduced into the polymer chain by using the bis(2-methoxyphenyl) oxalate ester. In the prior art, diphenyl oxalate esters have been described as a constitutive component in the production of polyesters, forming a polyester product comprising oxalate units, see e.g. WO2018211132, WO2018211133 and WO2020106144. However, the use of the particular bis(2-methoxyphenyl) oxalate ester according to the present invention, with its favorable leaving group properties, has not been described or suggested.

Guaiacol (2-methoxyphenol), which is produced as a side product in the present process, is considerably less toxic than phenol, which is typically produced. Furthermore, guaiacol can be sourced from the abundantly available renewable lignin. Notably, the inventors have found that diguaiacyl oxalate is significantly more reactive than diphenyl oxalate in transesterification reactions, advantageously resulting in reduced polymerization times and temperatures.

In the process according to the invention bis(2-methoxyphenyl) oxalate is reacted with the pre-polycondensation product of step (a) in a molar amount that is ideally about half the amount of the total amount of alcohol end groups present in the pre-polycondensation product of step (a). The addition of the bis(2-methoxyphenyl) oxalate may be done either in portions or all at once, depending on the circumstances and the desired product. With a stoichiometric ratio of the bis(2-methoxyphenyl) oxalate ester groups to the reactive alcohol end groups (i.e. 0.5 equivalent of bis(2-methoxyphenyl) oxalate to 1 equivalent of alcohol end groups) it is likely that a very high molecular weight can be obtained. Thus, ideally, and if appropriate, the amount of moles of the bis(2-methoxyphenyl) oxalate used in the process is about equal to 0.5 equivalents of the molar amount of alcohol end groups in the pre-polycondensation product.

According to an embodiment of the invention, the bis(2-methoxyphenyl) oxalate is added in polymerization step comprising polycondensation of the product of step (a) with bis(2-methoxyphenyl) oxalate in a molar amount that is equal to between about 0.4 and about 0.6 equivalents of the molar amount of alcohol end groups in the pre-polycondensation product of step (a). Preferably, the bis(2-methoxyphenyl) oxalate is added in polymerization step comprising polycondensation of the product of step (a) with bis(2-methoxyphenyl) oxalate in a molar amount that is equal to between about 0.45 and about 0.55 equivalents, more preferably between about 0.49 and 0.51 equivalents of the molar amount of alcohol end groups in the pre-polycondensation product of step (a)

In another embodiment of the invention, the bis(2-methoxyphenyl) oxalate is added in polymerization step comprising polycondensation of the product of step (a) with bis(2-methoxyphenyl) oxalate in a molar amount that is equal to or at least equal to 0.5 equivalents of the molar amount of alcohol end groups in the pre-polycondensation product of step (a).

The molar amount of alcohol end groups can be determined by proton nuclear magnetic resonance (¹H NMR).

The dicarboxylic acid or ester derivative thereof and the diol compound in step (a) can be any suitable diacid and any suitable diol known for polyester preparation. A person skilled in the art will understand what starting materials to select for the desired oxalate polyester (co)polymer product. Preferred dicarboxylic acids comprise (hetero) aromatic dicarboxylic acids, 1,4-cyclohexanedicarboxylic acid, diglycolic acid and C3-C18 aliphatic dicarboxylic acids which may be linear, cyclic or branched, in particular linear dicarboxylic acids of the formula HOOC(CH₂)ₙCOOH, wherein n is an integer of 1 to 20. In a preferred embodiment, step (a) of the process comprises reacting succinic acid, adipic acid (of which succinic acid is preferred), 2,5-furandicarboxylic acid or terephthalic acid or an ester derivative of said acids (wherein diguaiacyl ester derivatives may be preferred) with a diol, preferably with isosorbide, and optionally another diol. Instead of isosorbide, or in combination with isosorbide, suitably also other secondary diols may be selected from cyclic or non-cyclic, preferably aliphatic, diols, especially from other 1,4:3,6-dianhydrohexitols, and from cis- and/or trans-2,2,4,4-tetramethyl-1,3-cyclobutanediol. Said other optional diol (i.e. the diol used in addition to isosorbide) preferably is a linear aliphatic diol, preferably selected from 1,3-propanediol, 1,4-butanediol, 1,5-pentanediol, 1,6-hexanediol, cyclohexanedimethanol, neopentylglycol and diethyleneglycol.

Interesting oxalate polymer compounds can be prepared by using bis(2-methoxyphenyl) oxalate according to the present invention, especially when the at least one diol is isosorbide, thereby producing polyester (co)polymers at least comprising isosorbide and oxalate units. Properties like biodegradability and lifetime of polyisosorbide oxalate (co)polymers can effectively be tuned by carefully selecting other monomer units to be built into the polymer structure.

The diol in step (a) of the process of this invention may in fact be any suitable diol and may be selected from primary and secondary diols (for the latter vide supra). Suitably, in the case of primary diols, any primary diol is selected from C2-C18 aliphatic diols, in particular from linear, cyclic or branched, saturated C2-C12 aliphatic diol compounds, and preferably from ethylene glycol, 1,3-propanediol, 1,4-butanediol, 1,5-pentanediol, 1,6-hexanediol, diethyleneglycol, neopentylglycol, 1,4-cyclohexanedimethanol, and acetals of polyols.

The diol compound in the two-step process described herein above may also be an oligomer with alcohol functionalities. A preferred diol compound is bis(2-hydroxyethyl) terephthalate, when a therephthalate polyester is the desired end product. Preferably, the process comprises reacting bis(2-hydroxyethyl) terephthalate and terephthalic acid in step (a) to form ethylene terephthalate oligomers comprising alcohol end groups, wherein preferably the ratio of bis(2-hydroxyethyl) terephthalate to terephthalic acid is in the range of 1.01:1 to 1.1:1.

According to the process of the invention, a pre-polycondensation product is formed in step (a) by an esterification/transesterification step wherein at least one dicarboxylic acid or an ester derivative thereof is/are reacted with an excess of at least one diol compound or otherwise producing such pre-polycondensation product. By “otherwise producing” is herein understood a different process from the esterification/transesterification step that produces the pre-polycondensation product. Examples of such a different process include recycling or decomposition processes of polyesters.

A preferred embodiment of the process of this invention comprises reacting (the recycling product) bis(2-hydroxyethyl) terephthalate directly with bis(2-methoxyphenyl) oxalate to form polyethylene terephthalate oxalate polyester (co)polymers. Thus, in step (a) bis(2-hydroxyethyl) terephthalate is produced as pre-polycondensation product, which in step (b) is polymerized by polycondensation with bis(2-methoxyphenyl) oxalate to form a polyethylene terephthalate oxalate copolyester. Particularly, when bis(2-hydroxyethyl) terephthalate is used with bis(2-methoxyphenyl) oxalate in an equimolar amount, a polyethylene terephthalate oxalate copolyester may be obtained wherein terephthalate monomer units and oxalate monomer units are present in a 1:1 ratio.

The currently claimed process, using the highly reactive bis(2-methoxyphenyl) oxalate, has demonstrated to solve problems previously encountered with the low reactivity of isosorbide. High yields are obtained, and there is no need for compensation of any diol losses, as full incorporation is observed of the isosorbide used in the feed. The increased reactivity of the bis(2-methoxyphenyl) oxalate allows to select polymerization conditions relatively mild and reaction times relatively short, even when no catalyst is added. The process of this invention is therefore preferable for the production of polyoxalates from isosorbide with high molecular weights, which is also applicable for larger scales.

Depending on the chosen length of the pre-polycondensation product prepared in step (a), according to the process of the invention different contents of oxalate can be incorporated into the polymers, which allows for tunability of properties of the oxalate polyester (co)polymers, for example thermal properties and biodegradation lifetime.

When the polymer product of the currently claimed process comprises units derived from 1,2-diols (such as units derived from mono ethylene glycol, 1,2-propanediol, 1,2-butanediol, 2,3-butanediol and 1,2-cyclohexanediol), the temperature of the polycondensation in step (b) should preferably be not be higher than 230° C. At higher temperatures, it is believed that an intermediate oxalate species is formed, that is (without being bound to theory) possibly a part of the polymer chain, which species forms a six membered ring with the 1,2-diol derived units. At elevated temperature, higher than 230° C., and reduced pressure such ring compound can be removed from the polymer, while leaving behind a polymer with a undesired reduced oxalate content (with respect to the oxalate used in the feed). Thus, in an embodiment, the invention relates to a process, wherein an oxalate polyester (co)polymer product is produced comprising units derived from 1,2-diols, the process comprising performing the polycondensation in step (b)—or similarly in step (bb)—at a temperature of at most 230° C.

The process of the invention advantageously may comprise adding in step (a) a monohydric alcohol (solvent) with a boiling point at ambient pressure of equal to or higher than 175° C. up to equal to or lower than 300° C. and an acid dissociation constant (pKa) of equal to or less than 12.0 and equal to or more than 7.0, in an amount of 2.5-100 weight % with regard to the total weight of all dicarboxylic acids or ester derivatives thereof and diol compounds together. This has a facilitating effect in the process to produce high molecular weight polyester (co)polymers, which effect is unexpected, as for example mono-alcohols are known to be “terminators” in certain polymerization reactions, sealing the ends of growing polymeric chains. In the monohydric alcohol the hydroxy group is the only reactive functional group. The amount of the alcohol used is preferably 5 to 95%, 10 to 90 weight %, and particularly 20 to 80 weight %, and especially 30 to 70 weight %. In particular, the alcohol is an optionally substituted phenol, in particular selected from phenol, 4-methylphenol, 4-ethylphenol, 2-methoxyphenol (guaiacol), 4-methoxyphenol, 4-ethyl-2-methoxyphenol, 4-chlorophenol, and any combination thereof. A highly preferred monohydric alcohol is 2-methoxyphenol. The monohydric alcohol may serve as a reactive diluent in the reaction mixture, which may be desirable or considered necessary under certain circumstances. If deemed suitable, in addition to the monohydric alcohol, also an inert solvent, in particular diphenyl ether, dimethoxybenzene, etc., may be added to the reaction. Advantageously, when using monohydric alcohol in the presently claimed process, and when compared to polymerization techniques known in the art which start from a mixture of monomers, less of certain compounds are lost during polymerization. For example, more isosorbide and/or succinic acid, respectively, may be incorporated into resulting polyester (co)polymers when a monohydric alcohol is used in step (a) of the process.

The process of the invention may be performed in the presence or absence of (trans)esterification/polycondensation catalysts. Therefore, another embodiment relates to the process according to this invention, comprising the use of a catalyst, preferably a metal-containing catalyst. The catalyst preferably is used in amounts from 0.01 mole % to 0.5 mole % with regard to the total amount of monomers (in moles). Such metal-containing catalyst may for example comprise derivatives of tin (Sn), titanium (Ti), zirconium (Zr), germanium (Ge), antimony (Sb), bismuth (Bi), hafnium (Hf), magnesium (Mg), cerium (Ce), zinc (Zn), cobalt (Co), iron (Fe), manganese (Mn), calcium (Ca), strontium (Sr), sodium (Na), lead (Pb), potassium (K), aluminium (Al), and/or lithium (Li). Examples of suitable metal-containing catalysts include salts of Li, Ca, Mg, Mn, Zn, Pb, Sb, Sn, Ge, and Ti, such as acetate salts and oxides, including glycol adducts, and Ti-alkoxides. Preferably the metal-containing catalyst is a tin-containing catalyst, for example a tin(IV)- or tin(II)-containing catalyst. More preferably the metal-containing catalyst is an alkyltin(IV) salt and/or alkyltin(II) salt. Examples include alkyltin(IV) salts, alkyltin(II) salts, dialkyltin(IV) salts, dialkyltin(II) salts, trialkyltin(IV) salts, trialkyltin(II) salts or a mixture of one or more of these. These tin(IV) and/or tin(II) catalysts may be used with alternative or additional metal-containing catalysts. A preferred metal-containing catalyst is n-butyltinhydroxide oxide.

Favorably, in another embodiment, the process according to the invention may be performed in the absence of a metal catalyst. Surprisingly, even when no metal catalyst is added in that process, high molecular weight polyester (co)polymers can be obtained. Also, for the preparation of polyethylene terephthalate oxalate polyester (co)polymers, the process according to the invention is preferably performed in the absence of a metal catalyst, the products being more stable towards oxalate loss.

The absence of a metal catalyst in the preparation of polyesters is most interesting from a sustainability and toxicity point of view. If such metal catalyst free polymers might find their fate in nature, or would be composted, no metal catalyst buildup or pollution of the metal salts in the environment would result. The absence of metal catalyst is also valuable for food and medical applications, where leaching of the catalyst could be a serious concern. In addition, also depletion of natural resources is getting problematic: since efficient removal of low amounts of metal catalyst (typically used in polyester synthesis) from waste plastics is almost impossible, depletion of rare metal reserves is a consequence of the use of such catalysts. This already is a big concern for antimony, which in fact is the preferred metal in PET catalysis.

The process according to the invention can be carried out in a batch-wise, semi-batchwise or continuous mode. If applicable, the esterification/transesterification stage and the polycondensation stage may conveniently be carried out in one and the same reactor, but may also be carried out in two separate reactors, for example where the esterification/transesterification stage is carried out in a first esterification/transesterification reactor and the polycondensation stage is carried out in a second polycondensation reactor.

In any introduction stage the monomers may be introduced into the reactor simultaneously, for example in the form of a feed mixture, or in separate parts. The monomers may be introduced into the reactor in a molten phase or they can be molten and mixed after introduction into the reactor.

The (trans)esterification stage is performed according to procedures known in the art, but is preferably carried out in a reaction time in the range from equal to or more than 0.5 hour, more preferably equal to or more than 1.0 hour, to equal to or less than 20.0 hour, preferably to equal to or less than 10 hours, more preferably equal to or less than 6.0 hour. During a (trans)esterification stage, the temperature may be stepwise or gradually increased. The esterification/transesterification stage is preferably carried out under an inert gas atmosphere, suitably at ambient pressure or slightly above that, e.g. up to 5 bar.

The polycondensation stage is performed according to procedures known in the art, but is preferably carried out in a reaction time in the range from equal to or more than 0.5 hour, more preferably equal to or more than 1.0 hour, to equal to or less than 8.0 hours, more preferably equal to or less than 6.0 hours. During a polycondensation stage, the temperature may be stepwise or gradually increased. The polycondensation may suitably be carried out at a temperature equal to or higher or a bit lower than the temperature at which the (trans)esterification stage is carried out depending on the type of polyester (co)polymers. The (trans)esterification stage may for example be carried out at a temperature in the range from equal to or higher than 170° C., and depending on the desired polyester (co)polymer (e.g. high Tg polymers) preferably equal to or higher than 210° C., and even more preferably equal to or higher than 230° C., to equal to or lower than 260° C. However, if an oxalate polyester (co)polymer product is produced comprising units derived from 1,2-diols, the polycondensation is preferably performed at a temperature of at most 230° C. to avoid partial decomposition of the polymer. Suitably, the polycondensation stage is carried out at reduced pressure.

The process according to the invention may optionally further comprise, in case the polymer is semi-crystalline, after a recovery stage (i.e. wherein the polyester (co)polymer is recovered from the reactor), a stage of polymerization in the solid state. That is, the polyester (co)polymer may be polymerized further in the solid state, thereby increasing chain length. Such polymerization in the solid state is also referred to as a solid state polymerization (SSP). Such a solid state polymerization may allow to further increase the number average molecular weight of the polyester (co)polymer. If applicable, SSP can further advantageously enhance the mechanical and rheological properties of polyester copolymers before injection blow molding or extruding. The solid state polymerization process preferably comprises heating the polyester (co)polymer in the essential or complete absence of oxygen and water, for example by means of a vacuum or purging with an inert gas. Generally, solid state polymerization may suitably be carried out at a temperature in the range from equal to or more than 150° C. to equal to or less than 220° C., at ambient pressure (i.e. 1.0 bar atmosphere corresponding to 0.1 MegaPascal) whilst purging with a flow of an inert gas (such as for example nitrogen or argon) or at reduced pressure, for example a pressure equal to or below 100 millibar (corresponding to 0.01 MegaPascal). The solid state polymerization may for example be carried out for a period in the range from equal to or more than 2 hours to equal to or less than 60 hours. The duration of the solid state polymerization may be tuned such that a desired final number average molecular weight for the polyester copolymer is reached. As discussed before, if an oxalate polyester (co)polymer product is produced comprising units derived from 1,2-diols, any process step is preferably performed at a temperature of at most 230° C. to avoid partial decomposition of the polymer, provided that the oxalate units are already present in the growing polymer next to the units derived from 1,2-diols.

The process according to the invention may be carried out in the presence of one or more additives, such as stabilizers, for example light stabilizers, UV stabilizers and heat stabilizers, fluidifying agents, flame retardants, ether formation suppressants and antistatic agents. Phosphoric acid is an example of a stabilizer applied in PET. Additives may be added at the start of the process, or during or after the polymerization reaction. Other additives include primary and/or secondary antioxidants. A primary antioxidant can for example be a sterically hindered phenol, such as the compounds Hostanox® 0 3, Hostanox® 0 10, Hostanox® 0 16, Ultranox® 210, Ultranox®276, Dovernox® 10, Dovernox® 76, Dovernox® 3114, Irganox® 1010 or Irganox® 1076. A secondary antioxidant can for example be a trivalent phosphorous-comprising compounds, such as Ultranox® 626, Doverphos® S-9228 or Sandostab® P-EPQ.

In a further aspect, the invention relates to new (co)polyesters obtainable by, or obtained by, the currently claimed process. The process allows the preparation of a range of existing and novel polyester (co)polymers, often with high molecular weights that conventionally would not be obtainable. In another preferred embodiment no catalyst is used in the entire process, allowing the production of metal catalyst free polyester (co)polymers, that may be advantageous for certain uses requiring the absence of any catalyst, such as medical uses of polyesters. Thus, in an embodiment, preferably the (novel) polyester (co)polymer that is produced is a metal catalyst free (meaning: no metals present above ICP detection levels, i.e. less than 1 ppm metals present) polyester (co)polymer, i.e. which was produced without addition of a metal catalyst. Preferred polyester (co)polymers are selected from:
metal catalyst free polyethylene oxalate having a number average molecular weight, as measured by gel permeation chromatography using poly(methyl methacrylate) as internal standard, of at least 8500 daltons;
metal catalyst free poly(ethylene oxalate co-terephthalate) with an oxalate monomer content of equal to or more than 5.0% up to equal to and lower than 99.9% relative to the total amount of dicarboxylic acid derived monomers, and a glass transition temperature of higher than 40° C. to equal to and lower than 77° C.;
(metal catalyst free) poly(ethylene oxalate-co-2,5-furanoate);
metal catalyst free poly(1,4-butylene oxalate-co-terephthalate);
poly(1,4-butylene oxalate-co-terephthalate) with a number average molecular weight of at least 16000 daltons, preferably 20000 daltons;
(metal catalyst free) poly(1,4-butylene oxalate-co-2,5-furanoate);
metal catalyst free poly(isosorbide oxalate co-succinate);
(metal catalyst free) poly(isosorbide oxalate co-succinate) with an oxalate monomer content of more than 5.0% up to equal to and lower than 49.9% relative to the total amount of dicarboxylic acid derived monomers;
(metal catalyst free) poly(1,3-propylene-co-isosorbide oxalate-co-terephthalate);
(metal catalyst free) poly(1,3-propylene-co-isosorbide oxalate-co-2,5-furanoate);
(metal catalyst free) poly(1,4-butylene-co-isosorbide oxalate-co-terephthalate);
(metal catalyst free) poly(1,4-butylene-co-isosorbide oxalate-co-2,5-furanoate).

The amounts of each of the different monomeric units in the polyester (co)polymer often can be determined by proton nuclear magnetic resonance (1H NMR). One skilled in the art would easily find the conditions of analysis to determine the amount of each of the different monomer units in the polyester (co)polymer. Other analysis methods can include depolymerization, followed by monomer quantification (versus standards). Polyesters can be depolymerized in water (hydrolysis), in alcohol, e.g. methanol (alcoholysis, e.g. methanolysis) or in glycol (glycolysis). An excess of depolymerization solvent ensures full depolymerization and a catalyst (e.g. a base) can accelerate the depolymerization.

The number average molecular weight (Mn) of the polyester (co)polymer(s) may vary and may depend for example on the added monomer type and amount, the presence or absence of a catalyst, the type and amount of catalyst, the reaction time and reaction temperature and pressure. Advantageously, the number average molecular weight of the polyester copolymer(s) according to the invention is at least 10000 grams/mole and preferably the number average molecular weight is equal to or more than 15000 grams/mole, particularly equal to or more than 18000 grams/mole, more preferably of equal to or more than 20000 grams/mole up to as high as 100000 grams/mole.

The weight average molecular weight (Mw) and the number average molecular weight (Mn) can be determined by means of gel permeation chromatography (GPC) at 35° C., using for the calculation poly(methyl methacrylate) (PMMA) or polystyrene (PS) standards as reference material, and using hexafluoro-2-propanol or dichloromethane, respectively, as eluent. All molecular weights herein are determined as described under the analytical methods section of the examples.

Suitably the polyester (co)polymer according to the present invention may have a polydispersity index (that is, the ratio of weight average molecular weight (Mw) to number average molecular weight (Mn), i.e. Mw/Mn) in the range from equal to or higher than 1.4 to equal to or lower than 2.8, in particular from equal to or higher than 1.5 to equal to or lower than 2.6.

The glass transition temperature (Tg) of the polyester copolymer can be measured by conventional methods, in particular by using differential scanning calorimetry (DSC) with a heating rate of 10° C./minute in a nitrogen atmosphere. All glass transition temperatures herein are determined as described under the analytical methods section of the examples.

The process of the invention provides the person skilled in the art with tools and options to tune the desired properties of the polyester (co)polymers. For example, depending on the desired application, specific polyester (co)polymers may be made which provide a desired biodegradability lifetime. This may be beneficial in the agriculture sector where coatings, bags, or packaging is temporary used for nutrition or protection of crops in the field. In addition, oxygen barrier properties of the polyester (co)polymers may be favorable, which is potentially interesting for coating and packaging with diminished environmental impact. Further, oxalate polyester (co)polymers prepared according to the invention may have high Tg, which may be exploited for several applications, e.g. for hygienic reasons in the food or medical sector, such as hot filling and sterilizing. The biocompatibility of oxalate polyester (co)polymers herein described, in combination with good mechanical properties that were observed, make the polyester (co)polymers interesting for biomedical applications, such as sutures, implants and controlled drug release systems.

The polyester (co)polymer obtainable by or obtained by the process of the invention can suitably be combined with additives and/or other (co)polymers and therefore the invention further provides a composition comprising said polyester (co)polymer and in addition one or more additives and/or one or more additional other (co)polymers.

Such composition can for example comprise, as additive, nucleating agents. These nucleating agents can be organic or inorganic in nature. Examples of nucleating agents are talc, calcium silicate, sodium benzoate, calcium titanate, boron nitride, zinc salts, porphyrins, chlorin and phlorin.

The composition according to the invention can also comprise, as additive, nanometric (i.e. having particles of a nanometric size) or non-nanometric and functionalized or non-functionalized fillers or fibres of organic or inorganic nature. They can be silicas, zeolites, glass fibres or beads, clays, mica, titanates, silicates, graphite, calcium carbonate, carbon nanotubes, wood fibres, carbon fibres, polymer fibres, proteins, cellulose fibres, lignocellulose fibres and nondestructured granular starch. These fillers or fibres can make it possible to improve the hardness, the stiffness or the permeability to water or to gases. The composition can comprise from 0.1% to 75% by weight, for example from 0.5% to 50% by weight, of fillers and/or fibres, with respect to the total weight of the composition. The composition can also be of composite type, that is to say can comprise large amounts of these fillers and/or fibres.

The composition can also comprise, as additive, opacifying agents, dyes and pigments. They can be chosen from cobalt acetate and the following compounds: HS-325 Sandoplast® Red BB, which is a compound carrying an azo functional group also known under the name Solvent Red 195, HS-510 Sandoplast® Blue 2B, which is an anthraquinone, Polysynthren® Blue R and Clariant® RSB Violet.

The composition can also comprise, as additive, a processing aid for reducing the pressure in the processing device. A mould-release agent, which makes it possible to reduce the adhesion to the equipment for shaping the polyester, such as the moulds or the rollers of calendering devices, can also be used. These agents can be selected from fatty acid esters and amides, metal salts, soaps, paraffins or hydrocarbon waxes. Specific examples of these agents are zinc stearate, calcium stearate, aluminium stearate, stearamide, erucamide, behenamide, beeswax or Candelilla wax.

The composition can also comprise other additives, such as stabilizers, etc. as mentioned herein above.

In addition, the composition can comprise one or more additional polymers other than the one or more polyester (co)polymers according to the invention. Such additional polymer(s) can suitably be chosen from the group consisting of polyamides, polystyrene, styrene copolymers, styrene/acrylonitrile copolymers, styrene/acrylonitrile/butadiene copolymers, polymethyl methacrylates, acrylic copolymers, poly(ether/imide) s, polyphenylene oxides, such as poly(2,6-dimethylphenylene oxide), polyphenylene sulfide, poly(ester/carbonate) s, polycarbonates, polysulphones, polysulphone ethers, polyetherketones and blends of these polymers.

The composition can also comprise, as additional polymer, a polymer which makes it possible to improve the impact properties of the polymer, in particular functional polyolefins, such as functionalized polymers and copolymers of ethylene or propylene, core/shell copolymers or block copolymers.

The compositions according to the invention can also comprise, as additional polymer(s), polymers of natural origin, such as starch, cellulose, chitosans, alginates, proteins, such as gluten, pea proteins, casein, collagen, gelatin or lignin, it being possible or not for these polymers of natural origin to be physically or chemically modified. The starch can be used in the destructured or plasticized form. In the latter case, the plasticizer can be water or a polyol, in particular glycerol, polyglycerol, isosorbide, sorbitans, sorbitol, mannitol or also urea. Use may in particular be made, in order to prepare the composition, of the process described in the document WO 2010/010282A1.

These compositions can suitably be manufactured by conventional methods for the conversion of thermoplastics. These conventional methods may comprise at least one stage of melt or softened blending of the polymers and one stage of recovery of the composition. Such blending can for example be carried out in internal blade or rotor mixers, an external mixer, or single-screw or co-rotating or counter-rotating twin-screw extruders. However, it is preferred to carry out this blending by extrusion, in particular by using a co-rotating extruder. The blending of the constituents of the composition is preferably done under an inert atmosphere, and can suitably be carried out at elevated temperature, provided that when the oxalate polyester (co)polymer comprises units derived from 1,2-diols, the temperature does not exceed 230° C. In the case of an extruder, the various constituents of the composition can suitably be introduced using introduction hoppers located along the extruder.

The invention also relates to an article, comprising a polyester (co)polymer according to the invention or a composition comprising a polyester (co)polymer according to the invention, and one or more additives and/or additional polymers. The polyester (co)polymer may conveniently be used in the manufacturing of films, fibres, injection moulded parts and packaging materials, such as for example receptacles. The use of the polyester (co)polymer is especially advantageous where such films, fibres, injection moulded parts or packaging materials need to be heat-resistant or cold-resistant.

The article can also be a fibre for use in for example the textile industry. These fibres can be woven, in order to form fabrics, or also nonwoven.

The article can also be a film or a sheet. These films or sheets can be manufactured by calendering, cast film extrusion or film blowing extrusion techniques. These films can be used for the manufacture of labels or insulators.

This article can be a receptacle especially for use for hot filling and reuse applications.

This article can be manufactured from the polyester (co)polymer or a composition comprising a polyester (co)polymer and one or more additives and/or additional polymers using conventional conversion techniques. The article can also be a receptacle for transporting gases, liquids and/or solids. The receptacles concerned may be baby's bottles, flasks, bottles, for example sparkling or still water bottles, juice bottles, soda bottles, carboys, alcoholic drink bottles, medicine bottles or bottles for cosmetic products, dishes, for example for ready-made meals or microwave dishes, or also lids. These receptacles can be of any size.

The article may for example be suitably manufactured by extrusion-blow moulding, thermoforming or injection-blow moulding.

The present invention therefore also conveniently provides a method for manufacturing an article, comprising the use of one or more polyester (co)polymers according to the invention and preferably comprising the following steps: 1) the provision of a polyester (co)polymer obtainable by or obtained by the process of this invention; 2) melting said polyester (co)polymer and optionally one or more additives and/or one or more additional polymers, to thereby produce a polymer melt; and 3) extrusion-blow moulding, thermoforming and/or injection-blow moulding the polymer melt into the article.

The article can also be manufactured according to a process comprising a stage of application of a layer of polyester in the molten state to a layer based on organic polymer, on metal or on adhesive composition in the solid state. This stage can be carried out by pressing, overmoulding, lamination, extrusion-lamination, coating or extrusion-coating.

Advantageously, the oxalate polyester (co)polymers produced according to the process of the invention can be used in 3D printing. In case very high molecular weights are desired, the use of alternative types of reactors could potentially be a solution, such as extruders and compounders that are known to be used with polymers produced with several types of chain extenders. For example, a spinning disk reactor is highly suitable for processing highly viscous polymers.

Due to the fact that oxalic acid is the strongest dicarboxylic acid, it is very reactive, which makes it very susceptible to esterification, but also makes its esters very susceptible to hydrolysis and alcoholysis. This means that the oxalate moieties in polyesters are very hydrolysable, especially compared to other carboxylic acid monomers. This in turn has a strong effect on its degradability as it facilitates both enzymatic and non-enzymatic hydrolysis of the polyester and therefore its biodegradability. Furthermore, due to the short chain length of the oxalate monomer, when combined with rigid monomers, it will result in high Tg polyesters. This provides the opportunity to design high Tg polyesters that are also biodegradable and in many cases even marine degradable, depending on the oxalate content of the polymer. These can be made from sustainable sources, as oxalate/oxalic acid can be produced from CO₂ or biomass.

### BRIEF DESCRIPTION OF THE DRAWINGS

FIG. 1. Overview of the days it takes to hydrolyze 10% of the total acid for the polymers with different oxalate content. Both the hydrolysis started under basic conditions and under neutral conditions are shown.

FIG. 2. TGA of polyethylene oxalate (co)polymers with different content of oxalate and terephthalate. The percentage indicates the amount of oxalate incorporated as determined by ¹H-NMR, the remaining content is terephthalate. Rama PET (included for comparison) is commercially obtained PET. The mass loss over time is shown as percentage of the total mass lost during the cycle. The heating cycle was performed from 25-550° C. with a heating rate of 5° C./min.

FIG. 3. TGA curve of the ethylene oxalate ring, PETO 50% without catalyst, and with 0.1 mol % of titanium catalyst. The mass loss over time is shown as percentage of the total mass lost during the cycle. The heating cycle was performed from 25-550° C. with a heating rate of 5° C./min.

The invention is further illustrated by the following non-limiting examples.

### EXAMPLES

### List of Abbreviations

BHET=bis(2-hydroxyethyl) terephthalate
BnSnOOH=butyltin hydroxide oxide hydrate
DCM=dichloromethane
DEG=diethylene glycol
DGO=bis(2-methoxyphenol) oxalate or diguaiacyl oxalate
DGT=bis(2-methoxyphenol) terephthalate or diguaiacyl terephthalate
FDCA=2,5-furandicarboxylic acid
ISO=isosorbide
OP=oxygen permeability
PBAT=polybutylene adipate terephthalate
PDI=polydispersity index
PEF=polyethylene furanoate
PEO=polyethylene oxalate
PET=polyethylene terephthalate
PETO=polyethylene terephthalate oxalate
PISA=polyisosorbide succinate
PISOX=polyisosorbide oxalate
PISOX-SA=polyisosorbide oxalate with succinic acid units
PrDO=1,3-propanediol
POTPI=poly(1,3-propylene-co-isosorbide oxalate-co-terephthalate)
RPM=rotations per minute
SSP=solid state polymerization
TCE=tetracholoroethane
TEA=triethylamine
THF=tetrahydrofuran
TGA=thermographic analysis
TPA=terephthalic acid
WVP=water vapor permeability

### Materials

1,6-hexanediol (99%), 1,5-propanediol (96%), neopentylglycol (99%), diethylene glycol (99%), trimethylamine (99%), titanium (IV) isopropoxide (97%), phenol (>99%), oxalyl chloride (98%) and terephthalic acid (98%) were supplied by Sigma Aldrich. Guaiacol (99%) and isosorbide (98%) were purchased from Carbosynth. Dimethyl oxalate (>99%), 1,3-propanediol (98%), cyclohexanedimethanol (99%; cis- and trans-mixture) and BHET (>85%) were bought from TCI chemicals. Note: BHET is produced from chemical recycling of PET; as a result of the recycling process BHET still contains a portion of the DEG which was present in the PET, here 2.2 mol %. Tetrahydrofuran (99%), dichloromethane (99%), diethyl ether (99%), sodium bicarbonate (99.5%), sodium sulfate (99%; anhydrous), sodium chloride (>99%) were supplied by VWR International. TCE-d2 (99.5%) was ordered from ABCR chemicals. Except for isosorbide, all chemicals were used as received. Titanium tetraphenoxide was produced as described in WO2003080705. Isosorbide was purified in-house.

### Materials-Isosorbide Purification

High purity isosorbide is required for polymerizations. However, despite being commercially produced, isosorbide of sufficient purity is not readily available. Therefore the commercially obtained isosorbide had to be purified. First, the isosorbide was crystallized from acetone, followed by a distillation step over sodium borohydride. The quality was assessed by 1H NMR and DSC purity analysis (>99.5%). However, a better lead for assessing the quality of the isosorbide was the polymerization itself. The commercial isosorbide gave a brittle and strongly colored polymer, indicating bad quality. After the crystallization step the color and quality of the polymer improved significantly. Literature sources suggested doing a distillation step over sodium borohydride [Garaleh M, et al. Macromol. Chem. and Phys. 2010; 211(11):1206-1214.] This step was found to be beneficial to improve the color of the final polymer.

1.6 Kg of isosorbide (Carbosynth) was dissolved in hot acetone (600 mL). The slightly yellow transparent solution was then transferred to a 2 L 1-neck flask. The solution was left to cool to R.T. and left overnight to crystallize. The next day, the solution was placed in a freezer (−20° C.) for 2 more days to continue crystallizing. After crystallization, the left over liquid was decanted off and the crystals were washed with 2× ethyl acetate (300 mL). At this stage there was 1257 g (78.6%) of isosorbide left in the flask. Next, 7 g 0.5% (w/w) of NaBH₄ was added. A long path distillation was set up. The flask was slowly heated by an oil bath (100° C.). Then vacuum was slowly applied to the distillation setup. When bubbling came to a minimum the temperature was slowly increased to 175° C. Isosorbide distilled over at 175° C. oil temperature and 0.3 mbar. The received isosorbide had a faint yellow glow as a liquid, but as a solid was completely white, yield 874 g (55%). The residue had a dark brown color (383 g).

### Characterization

### NMR

¹H-NMR and ¹³C-NMR spectra were recorded at appropriate frequencies on a Bruker AV 300 (1H, 300.10 MHz), a Bruker DRX300 (1H, 300.13 MHz), a Bruker AMX 400 (1H, 400.13 MHz) and a Bruker DRX 500 (1H, 499.91 MHz) spectrometers. Chemicals shift are referenced to residual proton in the specified solvent.

### DSC

Differential scanning calorimetry thermograms were obtained with a Mettler Toledo DSC 3 STAR^{e} system. Around 5 mg of sample was weighed in a standard aluminum crucible (40 μl). Next the sample was analyzed in three steps, under a nitrogen flow of 50 ml*min⁻¹. First, after stabilizing at 20° C. for 5 minutes, the sample was analyzed at a rate of 10° C.*min⁻¹ from 20-230° C. Second, the sample was cooled down to the starting temperature of 20° C. with a cooling rate of 50° C.*min⁻¹. Lastly, the first step is repeated, and the data of this cycle is used for reporting.

### TGA

Thermogravimetric analyses were obtained by a Mettler Toledo TGA/DSC 3 STAR^{e} system. Around 15 mg of sample was weighed in an aluminum crucible (100 μl). Next the sample was analyzed at a heating rate of 10° C.*min⁻¹ from 20-550° C. under a nitrogen flow of 50 ml*min⁻¹.

### GPC (Gel Permeation Chromatography)

Molecular mass distributions were determined by size exclusion chromatography (SEC) on a 1260 Agilent GPC System equipped with a generic PMMA calibrated column (Agilent) using HFIP as mobile phase at 1 mL/min and T=35° C. Refractive index detector (Chromaster 5450) and Intrisc viscosity meter (Viscostar) was used for analysis. ASTRA 6.1 (Wyatt technology) software was used for further processing.

### Procedure Compression Molding Films

Films used for barrier measurements were prepared by compression molding with the help of a thermal press (Carver Auto Four/3015-NE,H). Granulates of the polymer are dried in a vacuum oven overnight at 60° C. 2 mbar. A press shape (20*20 cm) is prepared by folding a long piece of aluminum foil 3 times to get 8 layers thick aluminum foil. Half a circle with a diameter of 10 cm is cut out of the foil. The foil is then folded open once to get a circle with a diameter of 10 cm and 4 layers thickness (˜0.1 mm). The aluminum foil press shape is then pre-pressed (10 Forcetons) in between two sheets of Teflon (20*20*0.14 cm) and two aluminum plates (20*20*3 cm). The sandwich is opened and 1.5 grams of polymer is transferred to the middle of the press shape. The polymer is pre-molten by placing the sandwich in the hot press at 190° C. for 2 minutes without pressing. Then the sandwich is pressed at 0.5 tons for 1 minute, 1 tons for 30 seconds, 2 tons for 30 seconds, 5 tons for 30 seconds, and 10 tons for 30 seconds. The sandwich is then removed from the press. The Teflon sheet with the polymer and press shape is separated from the sandwich and left to cool at a flat cold surface. When cooled down the pressing shape and Teflon sheets are removed to obtain the polymer film (˜100 μm). Multiple films were made and visually examined for bubbles and defects. The best film was selected for barrier measurements.

### Barrier Measurements

Oxygen and water barrier measurements were performed on a Totalperm (Permtech s.r.l) instrument. Calibration of the system was carried out with a standard PET film provided by Permtech (Italy), according to the ASTM F1927-14 standard.

### Injection Molding

Tensile bars were obtained with a Thermo Scientific HAAKE Minijet II apparatus equipped with an ISO-527-2-A5 mold. The pressure, cylinder temperature and mold temperature was set to the corresponding values (see supporting info). When reached, it was made sure the cylinder is clean from any previous runs. The mold is coated with water-based silicon mold release agent, and when dry, placed in the holder. Next 2.2-2.7 grams of polymer was weighed and transferred inside the cylinder. The polymer was left to melt for 2:00 min inside the cylinder. Then the cylinder was placed on top of the mold, door is closed, and the injection program is started. The mold is taken apart, and the sample is removed and examined for defects. The left over polymer is discharged, and the sample is taken from the mold.

A typical polymer tensile bar (ISO-527-2-A5) weighed 1.8 gram.

### Tensile Testing

The tensile bars were analyzed on an Instron 5565 machine with load cell (10 kN) and Instron strain gauge extensometer 2630-106 (25 mm). Sample size are set to width (4 mm), thickness (1.95 mm), parallel length (25 mm) and test speed (5 mm/s). When the maximum elongation of the extensometer was reached (100%) the extension of the frame was used to determine the elongation at break.

### Filament Making

The filament was made on a Precision 350 filament maker from the company 3Devo. The following settings were used: Heater 1 (135° C.), 2 (140° C.), 3 (140° C.), 4 (135° C.), screw speed (3.5 RPM), fan speed 15% and filament diameter 2.85 mm.

### Example 1. Diguaiacyl Oxalate from Dimethyloxalate and Guaiacol

1192 g guaiacol (9.6 mol; 2.94 eq), 386 g dimethyloxalate (3.27; 1 eq) and 2.9 g titanium tetraphenoxide (5 mmol; 1.7 meq) were transferred to a steel 2 L kiloclave (Buchi). The reactor pressure was set to 3 bar with a N₂ bleed of 2 L/h. The heater oil temperature was set to 275° C. (245° C. internal); when the reactor temperature reached 100° C. stirring speed was set to 100 RPM. The reaction was followed by removing and monitoring the products in the condensation flask. After 4 hours of reaction time the pressure was slowly lowered to 2 bars, and the reaction was continued for 2 hours. Next, the oil temperature was set to 250° C. (225° C. internal) and the pressure was slowly lowered to atmospheric pressure until the guaiacol slowly distilled over. When distillation decreased to a minimum, pressure was lowered further by using a vacuum pump. At a pressure of 10 mbar, the condensation flask was drained. Next, full vacuum was applied (<0.1 mbar) at an oil temperature of 260° C. to distill over the product. The condensation product (300 g) was dissolved in THF (500 mL), and left to crystallize overnight. The obtained crystals were filtered off and washed with 2×200 mL diethyl ether. The crystals were dried at 60° C. under reduced pressure (1 mbar). The obtained product (225 g) was analyzed by ¹H-NMR and DSC for its purity, which is typically above 99%.

### Example 2. Diguaiacyl Terephthalate

Diguaiacyl terephthalate (DTP) was synthesized by reacting two units of guaiacol with terephthaloyl chloride (TP-Cl) in THF as the solvent. Triethylamine (TEA) was used as internal base to neutralize the formed hydrochloric acid to form the corresponding triethylammonium chloride salt. Using an addition funnel, a mixture of guaiacol (21.3 g; 0.172 mol) and TEA (18.4 g; 0.182 mol) in 240 ml THF was slowly added (˜10 ml/min) to a 3-neck flask containing 120 ml THF and TP-Cl (16.9 g; 0.083 mol). The reaction mixture was heated to 40-50° C. with a water bath while stirring with a top stirrer at 100 rpm. After complete addition of the guaiacol mixture, the reaction mixture was heated to 60° C. for 45-60 minutes. The color of the reaction mixture changed from yellow to white and all the TP-Cl was dissolved after around 45 minutes. After the completion, the mixture was filtered with a glass filter while hot. The formed salt was washed twice with 100 ml warm THF (40-50° C.) and once with 100 ml cold THF. After washing the solvent THF was removed using a rotary vacuum evaporator. The product was redissolved in 300 ml DCM. Some white flakes remained undissolved. After washing with 200 ml NaHCO₃, 200 ml water and 200 ml brine in a separatory funnel, the organic layer was dried on magnesium sulfate. After removing the magnesium sulfate with the glass filter, the DCM was removed with the rotary evaporator. The product was dissolved in 300 ml THF at 70° C. to slowly recrystallize at room temperature. After recrystallizing overnight, the product was filtered with a glass filter and washed with 2×100 ml cold THF. After evaporation in the oven at 80° C. for 8 hours the final product was analyzed with 1H-NMR, which confirmed that all THF was removed from the product.

### Example 3. PISOX-SA from Succinic Acid, Isosorbide and DGO (Generic Description)

For the preparation of PISOX-succinic acid copolymers a two-step procedure was followed. In the first step isosorbide-succinate oligomers were synthesized. The oligomer synthesis step was complete when all of the water forming reactions were completed. This was indicated by the absence of acid and anhydride groups. Note: Water needs to be avoided for proceeding to the next step, as water would react with the oxalate to volatile species. This may eventually lead to an unbalance in acid to diol ratio, lowering the molecular weight.

Step 1—In a typical polymerization, a 100 mL three neck round bottom flask was charged with isosorbide (1 eq), succinic acid (0.1 to 1.0 eq), butyltinhydroxide-oxide (2.5*10-4 eq) and guaiacol (0.75 eq). The amount of succinic acid was added according to the desired succinate content of the polymer. The round bottom flask was put in an oil bath and equipped with a mechanical stirrer, nitrogen inlet and short path connected Schlenk flask, all suited for high vacuum. Nitrogen flow was set to 50 mL/min and the temperature of the oil bath was set to 238° C. The set temperature was reached in about 30 minutes. As soon as a homogeneous melt was observed the stirring speed was set to 100 RPM. The reaction is complete when there are no acids end groups left (thus, the end groups mainly consist of isosorbide), and varies depending on the succinate content, i.e. 3 hours is at least needed for the 0.5 equivalent and 6 hours for 0.1 equivalent.

Step 2—When complete, DGO is added to the reaction mixture so that the diol content equals the acid ester. The reaction mixture was stirred under a nitrogen flow at a temperature of 230-240° C. for 30 minutes. Next, guaiacol is removed by applying vacuum and increasing the temperature. Typically, the free guaiacol is removed over the course of 1 hour, depending on the scale. Lastly, full vacuum (<1 mbar) is applied for 2 hour at the melting temperature of the polymer, typically around 230-240° C.

Using the two-step synthesis strategy described here, several different PISOX-SA polymers were synthesized. The resulting polymers were analyzed for their molecular weight, molar composition and thermal properties, see Table 1.

### Example 4. PISOX-SA 50% (Detailed Example According to Process of Example 3)

(1) Oligomer synthesis—8.0806 g of Succinic acid (68.4 mmol; 0.5 eq), 20.000 g of Isosorbide (137 mmol; 1 eq), 12.7 g of guaiacol (102 mmol; 0.75 eq) and 7 mg of butyltinhydroxide-oxide (2.5*10-4 eq) was weighed in a 100 mL 3-neck round bottom flask. The round bottom flask was put in an oil bath and equipped with a mechanical stirrer, nitrogen inlet and short path connected Schlenk flask, all suited for high vacuum. Nitrogen flow set to 50 mL/min and temperature of the oil bath was set to 238° C. The set temperature was reached in about 30 minutes. As soon as a homogeneous melt was observed the stirring speed was set to 100 RPM.

(2) Polymerization—After 5 hours, 20.684 g of DGO (68.4 mmol; 0.5 eq) was added to the reaction flask. After 30 minutes of stirring and obtaining a homogenous melt, vacuum was applied and the temperature was set to 240° C. The pressure was reduced until guaiacol slowly came over (˜200 mbar). Next, the pressure was halved each 15 minutes. After around 1.5 hours full vacuum was applied (˜1 mbar), and was maintained while stirring for 1 hour at 240° C. Results, see Table 1.

TABLE 1
Molecular composition, molecular weight and thermal properties of the PISOX-SA
polymers. The molecular weights are determined by GPC (polystyrene standards) and
¹H-NMR. The thermal properties are determined by DSC and TGA.

| | Analysis method: | | | | | | | |
|---|---|---|---|---|---|---|---|---|
| | Feed | NMR | | | | | | |
| | Oxalate | Oxalate | NMR | GPC | GPC | GPC | DSC | TGA |
| | content | content | Mn | Mn | Mw | PDI | Tg | T_{d-5%} |
| | (mol %) | (mol %) | (kg/mol) | (kg/mol) | (kg/mol) | (Mw/Mn) | (° C.) | (° C.)¹ |
| PISOX-SA | 76.7 | 76.6 | 34 | 22 | 40 | 1.85 | 141 | 329 |
| 75% | | | | | | | | |
| PISOX-SA | 49.9 | 48.7 | 25 | 35 | 74 | 2.1 | 119 | 332 |
| 50% | | | | | | | | |
| PISOX-SA | 33.9 | 32.5 | 31 | 28 | 56 | 1.99 | 105 | 337 |
| 35% | | | | | | | | |
| PISOX-SA | 25.2 | 25.1 | 33 | 33 | 75 | 2.26 | 99 | 340 |
| 25% | | | | | | | | |
| PISOX-SA | 10.7 | 9.7 | 29 | 23 | 50 | 2.21 | 89 | 344 |
| 10% | | | | | | | | |
| PISOX-SA* | 50.0 | 50.7 | 16 | 16 | 32 | 1.96 | No catalyst | |
| 50% | | | | | | | | |
| PISOX-SA* | 24.6 | 21.3 | 8 | 12 | 25 | 2.04 | No catalyst | |
| 25% | | | | | | | | |
| PISOX-SA* | 10.8 | 15.5 | 32 | 34 | 89 | 2.64 | Ti-catalyst-no solvent | |
| 10% | | | | | | | | |

¹T_{d-5%} is the temperature where 5% of the initial mass was lost.
*adapted process - see last column

The first five PISOX-SA copolymers shown in Table 1 were synthesized in the presence of the solvent guaiacol and butyltin hydroxide oxide as catalyst. Based on the GPC measurements, their weight average molecular weights (Mw) ranged from 40 kDa to 75 kDa, and number average molecular weights (Mn) from 22 kDa to 35 kDa with a PDI (Mw/Mn) close to 2. ¹H-NMR confirmed the high molecular weights with Mn values ranging from 25 kDa to 34 kDa. This range of molecular weight resulted in a strong material which could be processed into tensile bars and films. The obtained molecular weight are considerably higher than for other isosorbide-succinate polymers reported in literature.

In two other PISOX-SA (25% and 50% oxalate in feed, respectively) polymerizations no catalyst was used (Examples indicated with * in Table 2), and lower molecular weights were obtained 12/25 kDa (Mn/Mw) for PISOX-SA 25% and 16/32 kDa (Mn/Mw) for PISOX-SA 50%. Likely, the guaiacyl esters of succinate are slowly formed during the polymerization and are less reactive then guaiacyl oxalate esters. Even under high vacuum and temperature chain growth appeared to be slow. This is probably also the reason why the higher oxalate content PISOX-SA resulted in a higher molecular weight without catalyst, as there is less succinate present. Interestingly, the molecular weight of the non-catalyzed PISOX-SA polymers is still higher than for most reported isosorbide-succinate polymers (see e.g. Weinland D. H. et al. European Polymer Journal 164 (2022) 110964).

In another PISOX-SA polymerization (10% oxalate in feed) no solvent was used, and titanium (IV) isopropoxide was used as catalyst (Example indicated with * in Table 1), which resulted in the highest molecular weight of 34/89 kDa (Mn/Mw). However, succinic acid loss was significantly higher than for the reactions in the presence of guaiacol. For those reactions, the oxalate in the feed was close to the oxalate in the product (deduced by NMR), while the product of the solvent free reaction showed a loss of SA of almost 5%. This demonstrates the advantage of using a solvent: it can speed up the process of water removal and avoid loss of the monomers during the reaction. The reflux of the solvent keeps monomers such as succinic acid and succinate anhydride in the reactor, which otherwise would more easily sublime. The polymerization with titanium (IV) isopropoxide in this case also shows it is possible to produce high molecular weights with a titanium catalyst. Titanium can be an interesting alternative, as the toxicity of tin catalysts can be of concern for some applications.

### Barrier Properties of

Several PISOX-SA polymers were processed into a film of 100 μm. The films were tested for their oxygen and water barrier under different conditions. The water transmission rate was tested at 90% relative humidity 38° C. and the oxygen transmission rate at 0% and 50% relative humidity at 30° C.

PET has relatively good barrier properties, and is therefore commonly used as packaging material for food and household applications. By comparing the barrier properties of PISOX-SA to PET, an impression can be given of its potential as packaging material. The barrier properties also depend on the way the material is processed into a film e.g.: compression molding, film stretching and solution casting. Stretching is the most common method for PET.

However, as PISOX-SA polymers are amorphous, to have a proper comparison between the materials, the commercial PET was processed in the same way, in this case by compression molding. When comparing PISOX-SA to PET, it appeared that the oxygen barrier is 5 to 8 times better, depending on the relative humidity. However, the moisture barrier of PISOX-SA is almost 3 times lower than that of PET.

After converting the transmission rate to permeability, the barrier properties can be compared to literature values (Table 2). The reported permeability of the present experiment show to be similar to the reported values of PET, indicating good reliability of the method used. Currently there are limited biobased polymers which are biodegradable and possess good mechanical and barrier properties at comparable levels as traditional petroleum-based plastics.

When comparing the permeability of PISOX-SA with other commercially available biodegradable biobased polymers such as PLA and PBAT, it can be seen that PISOX-SA has a considerable lower OP, 37× lower than that of PLA and 124× lower than that of PBAT. The WVP is also lower, 1.7× for PLA and 6.2× for PBAT. Therefore, PISOX-SA may potentially be useful for packaging where good oxygen barrier is needed such as in modified atmosphere packaging, meat and cheese packaging.

TABLE 2
Overview of the (in-house) measured films and literature reported values.

| | | | | | |
|---|---|---|---|---|---|
| | OP | | WVP | | |
| Type of film | [(cm³ · μm)/(m² · 24 h · atm)] | Factor | [(g · μm)/(m² · 24 h · kPa)] | Factor | OP/WVP |

-experimental measurements-

| | | | | | | | |
|---|---|---|---|---|---|---|---|
| PISOX-SA 25 | 573 | (30°C.: 50%) | 1.0 | 718 | (38°C.: 90%) | 1.0 | 0.8 |
| PET (amorphous) | 4,720 | (30°C.: 50%) | 8.2 | 253 | (38°C.: 90%) | 0.4 | 18.7 |
| PET (Oriented) | 1311 | (23°C.: 50%) | 2.3 | 95 | (38°C.: 90%) | 0.1 | 15.2 |

-literature-

| PISOX | 247 | (23°C.: 50%) | 0.4 | — | | — | — |
|---|---|---|---|---|---|---|---|
| PISA | 720 | (30°C.: 50%) | 1.3 | 580 | (38°C.: 90%) | 0.8 | 1.24 |
| PET (amorphous) | 3,940 | (30°C.: 50%) | 6.9 | — | | — | — |
| PET-oriented | 1,680 | (25°C.: 45%) | 2.9 | 80 | (38°C.: 90%) | 0.1 | 21 |
| (mylar) | | | | | | | |
| PBAT (ecoflex) | 70,851 | (23°C.: 50%) | 124 | 4,470 | (38°C.: 90%) | 6.2 | 15.9 |
| PLA | 21,370-23,060 | (28°C.: 50%) | 37 | 1,204 | (38°C.: 100%) | 1.7 | 18-19 |
| Bio-PE | 54,356 | (23°C.: 0%) | 95 | ~76 | (38°C.: 100%) | 0.1 | 715 |

| | | | | | | |
|---|---|---|---|---|---|---|
| PEF (amorphous) | 722 | (30°C.: 50%) | 1.3 | — | — | — |
| PEF (oriented) | ~270 | (25°C.: 0%) | 0.5 | — | — | — |

Mylar [DuPont Teijn films http://usa.dupontteijinfilms.com/wp-content/uploads/2017/01/Oxygen_And_Walter_Vapour_Barrier_Properties_of_Flex_Pack_Films.pdf. Updated 2001. Accessed Feb. 9, 2022], PLA [Flodberg, G. et al. European Polymer Journal. 2015; 63: 217-226], PEF and PET [Wang, J. et al., Journal of Polymer Science Part A: Polymer Chemistry. 2017; 55(19): 3298-3307], PBAT [Wu, Feng 2021; 222 Qin, Pengkai 2021], Bio-PE [Wu, F. et al. Progress in Polymer Science. 2021; 117: 101395], PEF-Oriented [van Berkel, J. G. On the physical properties of poly (ethylene 2, 5-furandicarboxylate) DOI: 10.13140/RG.2.2.23466.16323], PISOX [Kurachi, K. et al. WO2005103111] and overview of others [Wang, J. et al. 2018 ACS Sustainable Chemistry & Engineering. 2018; 6(1): 49-70].

### Hydrolysis of PISOX-SA

To determine the different degradation rates of the PISOX-SA copolymers, a hydrolysis experiment was set up. The hydrolysis experiment is based on the color development of an universal indicator. The PISOX-SA copolymers were grinded into a powder, sieved (5-600 μm) and added to a glass vial with water and universal indicator. Since esters hydrolyze into carboxylic acids, the pH of the solution changes depending on the state of hydrolysis. The color of the universal indicator is pH dependent, and thus relates to the state of hydrolysis. To follow the color development of the solutions, a timelapse was taken of the samples with a frequency of 2 hours. To enhance homogeneity of the solutions, high frequency vibrations were employed at the stands every 12 hours. The temperature was kept constant at 25° C. by a climate-controlled incubator. The samples were also stored in the dark, and only received light when being photographed. Two different starting pH were used for the hydrolysis, pH 7 and pH 11. The main advantage of starting at a higher pH is that there is wider range of color development. pH 7 is most interesting due to its neutral starting point, being most close to real scenario applications. Ten solutions were made with integer pH values ranging from 2 to 11.

To identify the degradation stage of the copolymers, a clear color transition point was taken. The clear transition point for the polymers in the basic conditions was from purple (pH 11) to yellow (pH 6), and for the polymers in neutral conditions (pH 7) brown to orange (pH 3). Likely, oxalic acid has the strongest influence on the pH changes, it hydrolyses the fastest, has the highest solubility and is the strongest acid. The hydrolysis of the polymer which only contains succinic acid (PISA) showed very slow hydrolysis (did not show significant signs of hydrolysis over a time period of 84 days), and the polymer which only contains oxalic acid (PISOX), which showed very fast hydrolysis (reached the transition point in just 4 days).

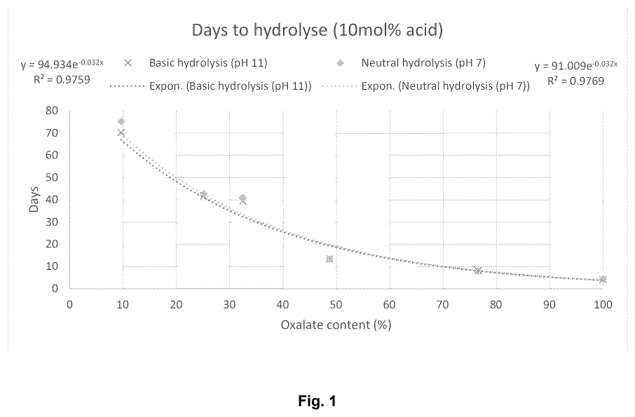

The 10% transition points were plotted for both neutral and basic conditions, see FIG. 1. As expected, the oxalate content has a strong effect on the hydrolysis rate. When 100% oxalate is used as acid only 4 days are needed to reach the transition point. In contrast, when 10% of oxalate and 90% succinic acid is used it takes almost 20 times longer, 75 days. The effect of oxalate content on the degradation time appears to be non-linear. However, for this range of oxalate content (10-100%) an exponential function seems to fit the experimental data well with a R² of 0.98. For the basic hydrolysis this corresponds to the following equation: (95e-0.032×) and for neutral conditions (91e-0.032×). Surprisingly, starting from basic conditions (pH 11) did not show to have a considerable effect on the hydrolysis rate and give comparable results to a neutral starting point (pH 7). Typically the pH is an important factor influencing the hydrolysis rate. This could indicate that the hydrolysis is mainly limited by the contact with water in the polymer matrix and is not limited by the hydrolysis reaction conditions.

### Example 5. PETO 50% from BHET and DGO-without Catalyst

Pre-drying BHET—30.000 g of BHET (118 mmol; 1 eq) was weighed in a 100 mL 3 neck round bottom flask. The round bottom flask was put in an oil bath and equipped with a mechanical stirrer, nitrogen inlet and short path connected Schlenk flask, all suited for high vacuum. Nitrogen flow set to 50 mL/min and temperature of the oil bath was set to 140° C. The set temperature was reached in about 15 minutes. As soon as a homogeneous melt was observed the stirring speed was set to 100 RPM. The temperature was kept at 140° C. for 1 hour.

Polymerization—After 1 hour, 35.134 g of DGO (116.2 mmol; 0.985 eq) was added to the BHET. Temperature was set to 175° C. As soon as a homogeneous melt was observed the stirring speed was set to 100 RPM. The temperature was kept at 175° C. for 1 hour. Next, vacuum was applied and the temperature was set to 190° C. The pressure was reduced until guaiacol slowly came over (˜125 mbar). Next, the pressure was halved each 15 minutes. When 10 mbar was reached the temperature was increased to 210° C. After around 2 hours full vacuum was applied (˜1 mbar), and was maintained while stirring for 1 hour. For results, see Table 2.

### Example 6. PETO 25% from BHET, TPA and DGO-without Catalyst

(1) Oligomer synthesis—20.000 g of BHET (78.7 mmol; 1 eq), 6.2731 g of TPA (37.8 mmol; 0.48 eq) and 4 g of guaiacol (32.2 mmol; 0.4 eq) was weighed in a 100 mL 3 neck round bottom flask. The round bottom flask was put in an oil bath and equipped with a mechanical stirrer, nitrogen inlet and short path connected Schlenk flask, all suited for high vacuum. Nitrogen flow set to 50 mL/min and temperature of the oil bath was set to 238° C. After 2.5 hours a clear melt was observed.

(2) Polymerization—An hour after a clear melt was observed, 10.0 g DGO (33.1 mmol; 0.42 eq) was added to the reaction flask. The pressure was reduced until guaiacol slowly came over (˜300 mbar). Next, the pressure was halved each 15 minutes. After around 2 hours full vacuum was applied (˜1 mbar), and was maintained while stirring for 1 hour.

By the two-step procedure described herein in Example 6, PETO polymers were synthesized with varying content of oxalate. Their molecular composition, thermal properties and molecular weight were analyzed (see Table 2).

TABLE 2
Overview of the different PETO polymers

| | | Analysis method: | | | | | | | | |
|---|---|---|---|---|---|---|---|---|---|---|
| | | Feed | NMR | NMR | | | | | | |
| | | Oxalate | Oxalate | DEG | NMR | GPC | GPC | GPC | DSC | |
| | | content | content | content | Mn | Mn | Mw | PDI | Tg | DSC |
| | | (mol %) | (mol %) | (mol %)^{a} | (kg/mol) | (kg/mol) | (kg/mol) | (Mw/Mn) | (° C.) | Tm (° C.) |
| compar- | PEO | 100 | — | n.d. | n.d. | 4.4 | 8.9 | 2.03 | 35.5 | 173.5 |
| ative | | | | | | | | | | |
| Ex. 5 | PETO-50 | 49.5 | 49.3 | 1.7 | 21.3 | 17.9 | 35.6 | 1.99 | 57.9 | 184.6^{b} |
| Ex. 6 | PETO-35 | 33.9 | 24.5 | 2.7 | 17.1 | 14.7 | 26.7 | 1.82 | 66.0 | 197.6 |
| Ex. 6 | PETO-25 | 22.0 | 18.2 | 2.5 | 14.0 | 17.0 | 33.4 | 1.96 | 66.8 | 214.3 |
| Ex. 6 | PETO-25 | 22.1 | 19.3 | 2.5 | 13.7 | 15.4 | 33.4 | 2.17 | 67.1 | 214.9 |
| Rama | PET^{c} | — | — | 2.5% | 41.3 | 36.8 | 74.5 | 2.03 | 78.7 | 249.4 |
| PET | | | | | | | | | | |

^{a}The used BHET for polymer synthesis contains 2.2 mol % DEG (based on total TPA)
^{b}Crystallization appeared to be very slow, and was observed (182.4° C.) from a slow cooling cycle of −0.5° C./min from 200° C., or after SSP 160° C. for 6 hours, the reported value.
^{c}The Rama PET also contains additives and a portion of isophthalic acid, which should be noted when comparing them to the synthesized polymers.

### Thermogravimetric Analyses of PETO Vs PET

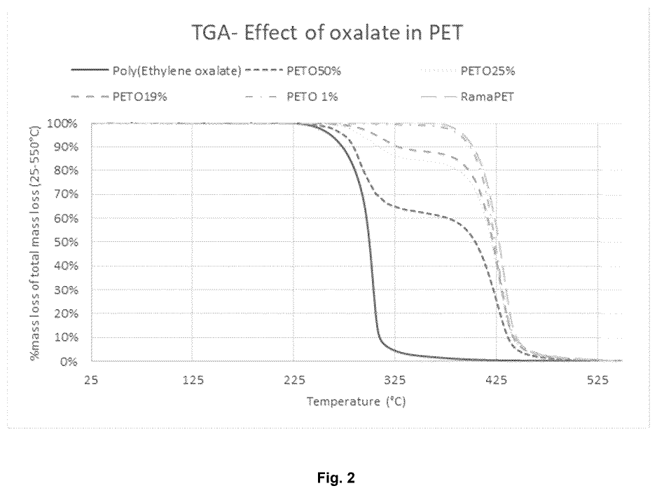

When having a closer look at the thermal weight loss of the PETO polymers by TGA, two main temperature ranges can be observed where there is a significant mass loss (FIG. 2). The first temperature range likely corresponds to the formation and loss of the ethylene oxalate ring. This is supported by the observed trend in weight loss according to the amount of oxalate incorporated. The polymer consisting fully out of oxalate and ethylene glycol (PEO) looses 97% of its mass over the temperature range of 25-350° C., which is as expected, since all could be converted to the ethylene oxalate ring. For PET with 49% oxalate the mass loss decreases to 32.7%, which is close to the theoretical calculated weight loss (37%) by the formation of the ethylene oxalate ring. This observed trend continues for the other contents of oxalate. Another trend that can be observed from the TGA is the increase of thermal stability when the content of oxalate decreases.

A second stage of thermal degradation is observed above 350° C., with T (0) (the extrapolated onset temperature calculated by software) slightly above 400° C. and T (e) (end temperature calculated by software) around 445° C. for all PETO polymers. This degradation ‘behavior’ is very similar to what is observed for commercial PET, which has a similar T (o) and T (e). This also indicates that after the ethylene oxalate is formed and removed, PET is left behind.

### TGA in Absence of Catalyst

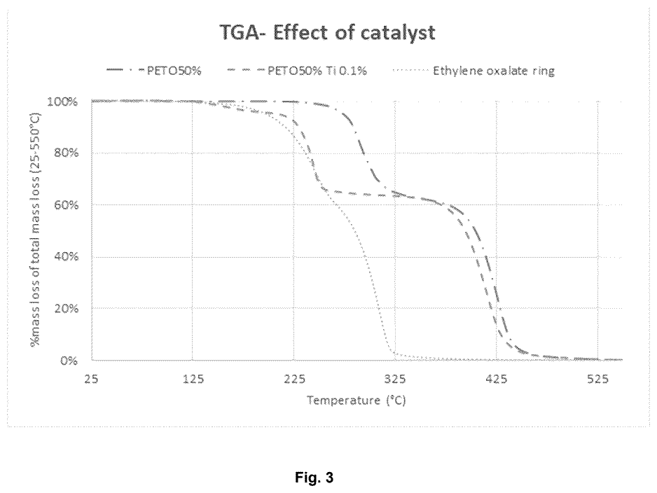

Also the absence of a catalyst has an advantage on the thermal stability. This can be seen by comparing the TGA curves obtained from PETO 50% without catalyst, and with 0.1 mol % of a titanium catalyst, titanium (IV) isopropoxide (FIG. 3). A significant decrease in thermal stability is seen when the catalyst is added, the first degradation stage is almost similar to the TGA of the ethylene oxalate ring itself. Although catalyst concentrations are typically much lower than 0.1 mol %, and come in many molecular forms, having no catalyst would likely provide the most thermal stable polymer, leading to higher yields and incorporation of oxalate. Besides this, a catalyst free polymer could provide multiple benefits. Recycling could be more efficient as there is no additional processes needed for the catalyst. If the polymer would find its fate in nature, there is no buildup of catalyst in the environment. Additionally, some of the common used catalyst get more scares, and avoiding them would provide both environmental and economic benefits. There are also strict requirements for catalyst usage in consumer food and medical products, making it easier to use the polymer in these fields.

### Barrier Properties of PETO

To be able to compare the barrier properties of PET and PETO, samples of the polymers were processed by an identical process. Amorphous films were made with an thickness of 100 μm by compression molding. The oxygen barrier (OTR) of the films were measured at 30° C. with a relative humidity of 0% and 50%. The water barrier (WVTR) was measured at 38° C. with a relative humidity of 90%.

| | | | OTR | OTR | WVTR | |
|---|---|---|---|---|---|---|
| | | | 0% RH | 50% RH | 90% RH | Film |
| | | Oxalate | [cm³/(m² · 24 h)] | [cm³/(m² · 24 h)] | [g/(m² · 24 h)] | thickness |
| # | | content | 30° C. | 30° C. | 38° C. | (μm) |
| 1 | PETO 50% | 47 | 14.21 | 12.98 | 12.5 | 100 |
| 2 | PETO 50% - | 49 | 8.79 | 8.31 | 7.76 | 80 |
| | crystalline | | | | | |
| 3 | PETO 50% - | 49 | 6.44 | 6.70 | 6.84 | 100 |
| | crystalline | | | | | |
| 4 | RamaPET | | 55.5 | 47.2 | 15.17 | 100 |
| | N180 | | | | | |
| 5 | PETO25% | 18 | 34.23 | 30.98 | 15.46 | 100 |

Incorporating oxalate in PET shows to noticeably improve the oxygen barrier, while maintaining a similar moisture barrier. With 50% of oxalate, the oxygen barrier improves almost 4 times for both 50% and 0% humidity. Surprisingly, the oxygen barrier found for the amorphous PETO50% film is similar to what is reported for a commercially oriented film of PET, Mylar (16.8 cm³/m²/24 hours 25° C. 45% RH) (http://usa.dupontteijinfilms.com/wp-content/uploads/2017/01/Oxygen_And_Walter_Vapour_Barrier_Properties_of_Flex_Pack_Films.pdf).

A film of PETO 50% was further crystallized by slowly cooling down in the hot press. The higher crystallinity improved the oxygen and moisture barrier by roughly a factor two compared to the amorphous film. If we assume the same enthalpy of crystallization as PET (140 J/g, http://www.tainstruments.com/pdf/literature/TN048.pdf), the degree of crystallinity of the film was 18%. Since a higher crystallinity percentage of 34% was reached after 6 hours of solid stating, the crystallinity of the film may increase further, and likely improve the barrier properties of the film even more. PETO polymers are therefore especially interesting for packaging applications. Thus, the introduction of oxalate units may provide improved shelf-life, or reduce the thickness needed for packaging materials.

### Mechanical Properties of PETO

Besides the well-known barrier properties PET, it also is known for having good mechanical properties. To see how oxalate affects the mechanical properties of PET, the polymers were processed by injection molding into tensile bars and impact bars. The tensile properties of PETO 50% were measured and compared to PET.

| | | | | | | | Elongation | |
|---|---|---|---|---|---|---|---|---|
| | | | | | Tensile stress at Yield | | at Break | |
| | Young's modulus | | Maximum Tensile stress | | (Offset 0.002 mm/mm) | | Max found | Samples |
| | (MPa) | | (MPa) | | (MPa) | | (%) | (amount) |
| Product | Value | Standarddev | Value | Standarddev | Value | Standarddev | Value | Value |
| PETO50% | 3316 | 91 | 74.6 | 1.9 | 57.8 | 2.8 | 26 | 6 |
| PET | 2666 | 194 | 70.5 | 0.2 | 50.1 | 2.3 | 107 | 3 |

Oxalate appears to significantly increase the rigidity of PET. When 50% of terephthalate is replaced with oxalate the Young's modulus increases roughly by 25%, from 2.6 GPa to 3.3 GPa. The maximum elongation at break decreased significantly, which is likely the results of the reduced flexibility. However, the tensile properties are quite similar to PET, especially in view of the online available data sheets. PETO shows a slight increase in ultimate tensile strength and the yield strength increase roughly by 20%.

The impact strength of PETO 50% was also determined, being 1.9 kJ/m² (Izod impact notched by an average of 4 samples) and showed to be similar to reported values of unmodified PET. Overall the mechanical properties of PETO are similar to those of PET, which is very promising.

### Hydrolysis of PETO

The hydrolysis of PETO 50% and PETO 18% was determined by following the pH changes over time. A known amount of polymer particles was submerged in water, the pH was visualized with a universal indicator and followed over time with a camera. The amount of water and weight of polymer which was used would result in a total diacid concentration of roughly 10 mM. The hydrolysis was started from pH 11 (NaOH) and pH 7 at 25° C.

PETO-50% released around 1 mM of acid under both basic and neutral conditions in around 20 days (pH 3 and 7). PETO-18% reaches this point in 111 days. PET did not show any hydrolysis in this time frame. On the other hand, PISOX, which contains 100% oxalate as diacid units, was also tested, and reaches the point in only 4 days. This demonstrates that the hydrolysis rate is strongly influenced by the oxalate content.

Ethylene glycol terephthalate esters are likely the slowest to hydrolyze, and therefore contribute little to the pH changes. In contrast, the ethylene glycol oxalate esters are readily hydrolysable and are the main pH influencer.

### Example 7. POTPI—Oxalate Terephthalate 1,3-Propanediol Isosorbide Copolyesters—with and without Catalyst

Three separate experiments were carried out:
1. POTPI without catalyst and transesterification carried out with DGT (see Example 2 for DGT).
2. POTPI with catalyst (Sn) and transesterification carried out with DGT.
3. POTPI without catalyst and transesterification carried out with TPA.

For each experiment, a 100 mL three neck round bottom flask was charged with the compounds listed in the tables below:

| | | |
|---|---|---|
| | Weight | |
| Compound | (g) | mmol |

1. No catalyst; with DGT

| | | |
|---|---|---|
| DGT | 5.19 | 13.7 |
| PrDO | 1.01 | 13.3 |
| ISO | 1.93 | 13.2 |

2. Catalyst; with DGT

| | | |
|---|---|---|
| DGT | 5.04 | 13.3 |
| PrDO | 1.01 | 13.2 |
| ISO | 1.99 | 13.6 |
| BnSnOOH | 2 mg | 0.01 |

3. No Catalyst; with TPA

| | | |
|---|---|---|
| TPA | 9.97 | 60.0 |
| PrDO | 4.57 | 60.1 |
| ISO | 8.75 | 59.9 |
| Guaiacol | 4.0 | 32.2 |

The catalyst was added in a 10 mg/mL BnSnOOH solution in toluene.

The round bottom flask was put in an oil bath and equipped with a mechanical stirrer, nitrogen inlet and short path connected Schlenk flask, all suited for high vacuum. The procedure for each experiment is listed below and consist of a transesterification step, followed by a polycondensation step:

1. Without Catalyst; from DGT

A transesterification step was carried out in 5 hours at 200° C. oil temperature, 100 RPM stir speed and a nitrogen flow of 50 mL/min. At the start of the polycondensation, 3.88 g (12.8 mmol) DGO was added to the flask. After 15 minutes, the temperature was raised to 220° C. and 200 mbar of vacuum was applied. After 1 hour, the temperature was raised to 240° C. and vacuum was lowered to 50 mbar. 1 hour later, temperature was set to 250° C. and full vacuum was applied <1 mbar. After one hour the atmosphere was replaced by nitrogen and the polymer was collected (4.5 g).

2. With Catalyst; from DGT

The transesterification step was carried out in 5 hours at 230° C. oil temperature, 100 RPM stir speed and a nitrogen flow of 50 mL/min. At the start of the polycondensation, 4.09 g (13.5 mmol) DGO was added to the flask. After 15 minutes, the temperature was raised to 240° C. and over the course of 30 minutes vacuum was slowly applied until <1 mbar was reached. After 2 hours, the atmosphere was replaced by nitrogen and the polymer was collected (3.7 g).

3. No Catalyst; from TPA

The transesterification step was carried out in 8 hours at 240° C. oil temperature, 100 RPM stir speed and a nitrogen flow of 50 mL/min. At the start of the polycondensation, 17.7 g (58.6 mmol) DGO was added to the flask. After 15 minutes, vacuum was slowly applied over the course of 1 hour until <1 mbar was reached. Full vacuum was continued for another hour, after which the atmosphere was replaced by nitrogen and the polymer was collected.

### Results in Table 4:

| | Feed | Feed | NMR | NMR | NMR | GPC | GPC | GPC | DSC |
|---|---|---|---|---|---|---|---|---|---|
| | Oxalate | ISO | Oxalate | ISO | Mn | Mn | Mw | PDI | Tg |
| | (%) | (%) | (%) | (%) | (kg/mol) | (kg/mol) | (kg/mol) | (Mw/Mn) | (° C.) |
| 1. No cat; | 48.3 | 49.8 | 45.3 | 50.8 | 24.9 | — | — | — | — |
| from DGT | | | | | | | | | |
| 2. Cat; | 50.4 | 50.7 | 48.2 | 50.9 | 21.5 | 26.8 | 55.2 | 2.1 | 95 |
| from DGT | | | | | | | | | |
| 3. No cat; | 49.4 | 50.5 | 42.9 | 50.3 | 22.9 | 20.5 | 40.0 | 2.0 | 100 |
| from TPA | | | | | | | | | |

Feed is based on the percentage of total acid added (DGO + TPA)
NMR content is based on the percentage of total acid in polymer chain

1. A process for production of an oxalate polyester (co)polymer, comprising use of bis(2-methoxyphenyl) oxalate to introduce oxalate monomer units into a polymer chain, comprising at least steps (a) and (b):
(a) an esterification/transesterification step wherein at least one dicarboxylic acid or an ester derivative thereof is/are reacted with an excess of at least one diol compound to form a pre-polycondensation product comprising alcohol end groups, or otherwise producing such pre-polycondensation product;
(b) a polymerization step comprising polycondensation of the product of step (a) with bis(2-methoxyphenyl) oxalate in a molar amount that is equal to between about 0.4 and about 0.6 equivalents of the molar amount of alcohol end groups in the pre-polycondensation product of step (a).

2. The process according to claim 1, wherein in step (a) the at least one dicarboxylic acid or an ester derivative thereof is selected from (hetero) aromatic dicarboxylic acids, 1,4-cyclohexanedicarboxylic acid, diglycolic acid and C3-C18 aliphatic dicarboxylic acids which are linear, cyclic or branched.

3. The process according to claim 1, wherein in step (a) the at least one dicarboxylic acid or an ester derivative thereof is selected from succinic acid, adipic acid, 2,5-furandicarboxylic acid or terephthalic acid or an ester derivative of said acid.

4. The process according to claim 1, wherein in step (a) the at least one diol is isosorbide.

5. The process according to claim 1, comprising reacting bis(2-hydroxyethyl) terephthalate and terephthalic acid in step (a) to form ethylene terephthalate oligomers comprising alcohol end groups, wherein the ratio of bis(2-hydroxyethyl) terephthalate to terephthalic acid is in the range of 1.01:1 to 1.1:1.

6. The process according to claim 1, wherein in step (a) producing the pre-polycondensation product bis(2-hydroxyethyl) terephthalate, which in step (b) is polymerized by polycondensation with bis(2-methoxyphenyl) oxalate to form a polyethylene terephthalate oxalate copolyester.

7. The process according to claim 1, wherein an oxalate polyester (co)polymer product is produced comprising units derived from 1,2-diols, the process comprising performing the polycondensation in step (b) at a temperature of at most 230° C.

8. The process according to claim 1, comprising adding in step (a) a monohydric alcohol with a boiling point at ambient pressure of equal to or higher than 175° C. up to equal to or lower than 300° C. and an acid dissociation constant of equal to or less than 12.0 and equal to or more than 7.0, in an amount of 2.5-100 weight % with regard to the total weight of all dicarboxylic acids or ester derivatives thereof and diol compounds together.

9. The process according to claim 1, wherein the process is performed in the absence of a metal catalyst.

10. A polyester (co)polymer obtainable by or obtained by a process according to claim 1.

11. A polyester (co)polymer according to claim 10, selected from
metal catalyst free polyethylene oxalate having a number average molecular weight, as measured by gel permeation chromatography using poly(methyl methacrylate) as internal standard, of at least 8500 daltons;
metal catalyst free poly(ethylene oxalate co-terephthalate) with an oxalate monomer content of equal to or more than 5.0% up to equal to and lower than 99.9% relative to the total amount of dicarboxylic acid derived monomers, and a glass transition temperature of higher than 40° C. to equal to and lower than 77° C.;
(metal catalyst free) poly(ethylene oxalate-co-2,5-furanoate);
metal catalyst free poly(1,4-butylene oxalate-co-terephthalate);
poly(1,4-butylene oxalate-co-terephthalate) with a number average molecular weight of at least 16000 daltons, as measured by gel permeation chromatography using poly(methyl methacrylate) as internal standard;
(metal catalyst free) poly(1,4-butylene oxalate-co-2,5-furanoate);
metal catalyst free poly(isosorbide oxalate co-succinate);
(metal catalyst free) poly(isosorbide oxalate co-succinate) with an oxalate monomer content of more than 5.0% up to equal to and lower than 49.9% relative to the total amount of dicarboxylic acid derived monomers;
(metal catalyst free) poly(1,3-propylene-co-isosorbide oxalate-co-terephthalate);
(metal catalyst free) poly(1,3-propylene-co-isosorbide oxalate-co-2,5-furanoate);
(metal catalyst free) poly(1,4-butylene-co-isosorbide oxalate-co-terephthalate); or
(metal catalyst free) poly(1,4-butylene-co-isosorbide oxalate-co-2,5-furanoate).

12. A composition, comprising the polyester (co)polymer according to claim 10, and in addition one or more additives and/or one or more additional other (co)polymers.

13. An article, comprising a composition according to claim 12.
